(19) United States
(12) Patent Application Publication
(10) Pub. No.: US 2025/0247362 A1
(43) Pub. Date: Jul. 31, 2025

(54) MODULAR MULTIFUNCTIONAL AIR COMBAT MANEUVERABILITY INSTRUMENTATION (ACMI) CYBERSECURITY APPLIANCE

(71) Applicant: Rockwell Collins, Inc., Cedar Rapids, IA (US)

(72) Inventors: Jonathan D. Drahos, Belle Plaine, IA (US); Sean D. Howard, Cedar Rapids, IA (US); Meghan K. Anderson, Elkhorn, NE (US)

(21) Appl. No.: 18/429,067

(22) Filed: Jan. 31, 2024

(51) Int. Cl. H04L 9/40

(52) U.S. Cl. CPC H04L 63/0236; H04L 63/0209; H04L 63/1425; H04L 63/1433

(57) ABSTRACT

A multifunctional cybersecurity appliance is physically installable between a processing environment (e.g., an aircraft or other mobile platform) and external networks with which the processing environment is in communication. The modular appliance combines multiple cybersecurity and cryptographic modules within a hardened housing or chassis. For example, a perimeter firewall provides a demilitarized zone (DMZ) network providing a first line of defense by admitting or denying inbound traffic from suspicious addresses or ports. Cryptographic modules encrypt and decrypt secure data traffic. Next-generation firewall (NGFW) components provide further packet inspection of decrypted inbound traffic to guard against internal attacks. A security information and event management (SIEM) module monitors event logs from other components of the appliance and generates an alert when anomalous activity is detected.

### BACKGROUND

Contemporary and next-generation mobile platforms (e.g., aircraft, ground-based vehicles, water-based vehicles) require up-to-date protection from cybersecurity vulnerabilities, even if the mobile platforms themselves are older legacy models. In some cases, legacy platforms may employ a patchwork or hybrid set of old and new technologies sourced from multiple vendors and/or requiring multiple and diverse licenses to operate. Further, as threats and requirements evolve, system-level protection from and defense against said threats (and fulfillment of said requirements) must evolve to match. Maintaining protection for legacy platforms may require a complete overhaul of system architecture from the ground up, but this is a complex, costly, high-overhead option for systems with high uptime requirements.

### SUMMARY

In an aspect, a modular cybersecurity appliance physically installable between an internal processing environment and an external network is disclosed. In embodiments, the modular security appliance includes a demilitarized zone (DMZ) network providing an outer firewall, filtering inbound data or communications traffic transmitted to the internal processing environment according to its set of packet inspection rules regulating formatting, integrity, validation, or other security policies. The DMZ network may further inspect outbound data or communications traffic in transit to the external network and passed by other components of the appliance (e.g., encrypted or decrypted). The appliance includes cryptographic modules for encrypting outbound traffic and decrypting inbound traffic. The appliance includes a next-generation firewall (NGFW) behind the cryptographic modules and performing packet inspection according to a distinct set of security rules and policies, e.g., different from those implemented by the DMZ network. For example, the NGFW may inspect inbound data packets passed by the DMZ network and decrypted, rejecting or flagging packets if inaccuracies or deficiencies not detectable when the packets were encrypted are present. The appliance includes as an innermost layer of security a security information and event management (SIEM) module monitoring event logs from other components of the appliance (and/or within the internal processing environment) and generating alerts if potential threats and/or anomalous behavior are detected.

In some embodiments, the appliance includes an out-of-band intrusion detection system (IDS) configured for outbound and inbound packet inspection independently of the main communications line through the appliance (e.g., the DMZ, NGFW, and/or other modular components) and generation of alerts if threats or malicious behavior are detected.

In some embodiments, the out-of-band IDS includes an intrusion prevention system (IPS) capable of executing countermeasures responsive to threats or behavior alerted by the IDS.

In some embodiments, the appliance further includes cross-domain solutions (CDS) for managing transmission and reception of data and communications traffic to and from networks or nodes having a different security classification than the internal processing environment, or transmission and reception through a security domain barrier.

In some embodiments, the appliance includes network data loss prevention (DLP) modules configured for preventing exfiltration of data or communications traffic based on a security level or classification of the intended destination (e.g., an external network or node thereof).

In some embodiments, the DLP modules block or drop outbound packets based on sufficient deviance of the security classification or level of the destination from that of the internal processing environment.

In some embodiments, the appliance filters inbound data traffic by accepting or admitting associated inbound packets, rejecting or dropping associated inbound packets, flagging inbound packets for downthread components of the appliance (or the internal processing environment), or routing the inbound packets to a specific destination within the appliance or the environment.

In some embodiments, the appliance filters outbound traffic by accepting or allowing outbound packets to be transmitted to their intended destination or rejecting/dropping outbound packets.

In some embodiments, the appliance further includes a security orchestration automation and response (SOAR) module connected to the SIEM module, the SOAR module capable of receiving and executing countermeasures responsive to event log threats generated by the SIEM module.

In some embodiments, the SIEM module monitors event logs from physical devices and/or systems of devices associated with the internal processing environment.

In some embodiments, the appliance is installed aboard a vehicle or mobile platform, and the devices or systems include sensors of the mobile platform.

In some embodiments, the devices or systems include locks for securing doors, windows, or areas of the mobile platform.

In some embodiments, the devices or systems include vehicular systems and subsystems.

In some embodiments, the appliance includes physical interfaces for installation between the internal processing environment and external network, the interfaces compatible with at least Ethernet networks, fiber channel networks, and/or MIL-STD-1553 data buses.

This Summary is provided solely as an introduction to subject matter that is fully described in the Detailed Description and Drawings. The Summary should not be considered to describe essential features nor be used to determine the scope of the Claims. Moreover, it is to be understood that both the foregoing Summary and the following Detailed Description are example and explanatory only and are not necessarily restrictive of the subject matter claimed.

### BRIEF DESCRIPTION OF THE DRAWINGS

The detailed description is described with reference to the accompanying figures. The use of the same reference numbers in different instances in the description and the figures may indicate similar or identical items. Various embodiments or examples (“examples”) of the present disclosure are disclosed in the following detailed description and the accompanying drawings. The drawings are not necessarily to scale. In general, operations of disclosed processes may be performed in an arbitrary order, unless otherwise provided in the claims. In the drawings:

FIG. 1 is a block diagram illustrating a modular cybersecurity appliance according to example embodiments of this disclosure;

FIG. 2 is a block diagram illustrating components of the modular cybersecurity appliance of FIG. 1; and

FIG. 3 is a block diagram illustrating additional components of the modular cybersecurity appliance of FIG. 1.

### DETAILED DESCRIPTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one” or “at least one,” and the singular also includes the plural unless it is obvious that it is meant otherwise.

Finally, as used herein any reference to “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination or sub-combination of two or more such features, along with any other features which may not necessarily be expressly described or inherently present in the instant disclosure.

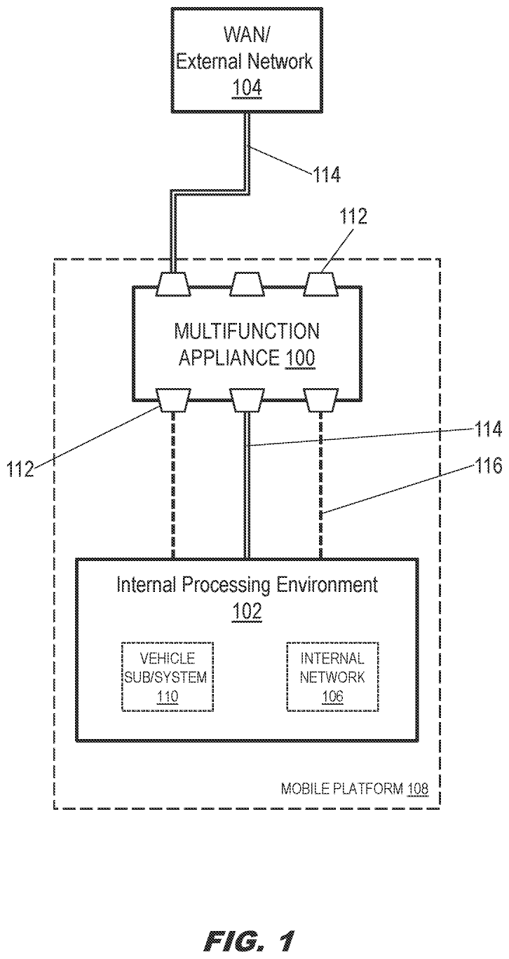

### FIG. 1—High Level Overview

Broadly speaking, embodiments of the inventive concepts disclosed herein are directed to a modular plug-and-play cybersecurity appliance physically installable between a vulnerable internal system and an external network. For example, the appliance may package a multi-functional cybersecurity suite aggregating multiple cybersecurity and cryptographic technologies into a durable chassis (e.g., 3-unit (3 U) or 6-unit (6 U) virtual path cross-connect (VPX) form factor) suitable for use in military vehicles.

Referring in particular to FIG. 1, the multifunctional cybersecurity appliance 100 may physically interface between an internal processing environment 102 and an external network 104 (e.g., a wide area network (WAN)). For example, the internal processing environment 102 may include an internal network 106, e.g., implemented aboard a mobile platform 108 (e.g., aircraft, ground-based or water-based vehicle), such that the multifunctional cybersecurity appliance 100 protects the internal network 106 as well as any vehicular systems and subsystems 110 (e.g., communications systems, navigation systems, operating systems, propulsion systems) in data communication with the external network 104.

In embodiments, the multifunctional cybersecurity appliance 100 may include one or more physical interfaces 112 compatible with a variety of formats and/or communications/data transfer protocols, e.g., Ethernet or fiber channel based networks, MIL-STD-1553 data bus. For example, the multifunction appliance 100 may be physically linked (114) and/or wirelessly linked (116) to the external network 104 as well as the internal networks 106 and/or vehicular systems/subsystems 110 in communication with the external network. In embodiments, any inbound or outbound data traffic exchanged between the internal processing environment 102 and the external network 104 may be filtered and/or monitored by the multifunction appliance 100. For example, the multifunction appliance 100 may block any inbound or outbound data traffic non-compliant with security policies enforced by components of the appliance (e.g., as described in greater detail below). Alternatively, the multifunction appliance 100 may admit or allow to pass any inbound or outbound data traffic in compliance with component security policies. Further, selected components of the multifunction appliance 100 may monitor inbound data traffic, attempting to detect and/or counter potential threats, exploits, and/or malicious behavior according to their associated policy sets. In embodiments, the multifunction appliance 100 may respectively provide for encryption and decryption of outbound and inbound data traffic exchanged by the internal processing environment 102 with the external network 104 and/or other friendly parties.

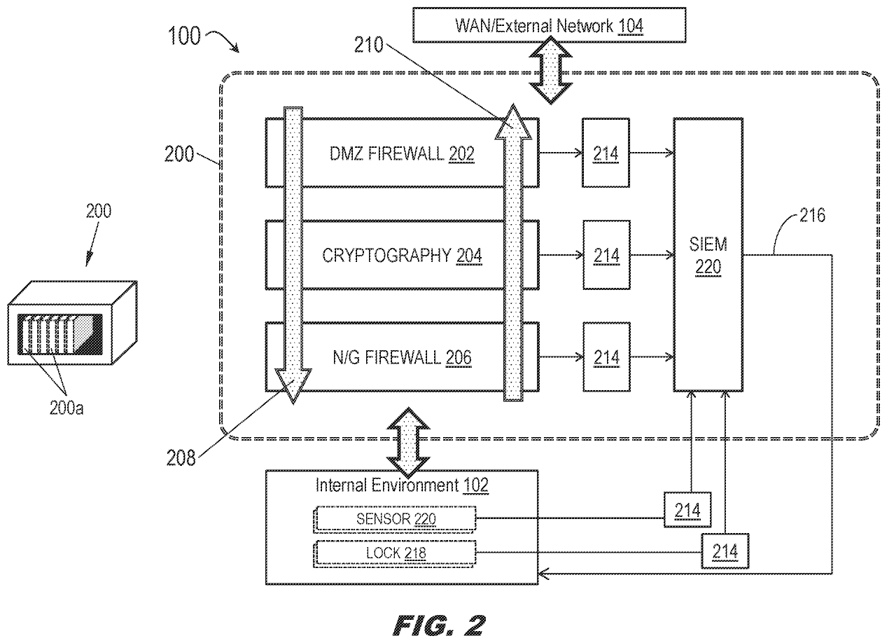

### FIG. 2—Appliance Components (Base)

Referring now to FIG. 2, the multifunctional cybersecurity appliance 100 is shown.

In embodiments, the multifunctional cybersecurity appliance 100 may combine diverse cybersecurity components within a hardened chassis 200 (e.g., housing). For example, the chassis 200 may comply with Sensor Open Systems Architecture (SOSA) technical standards for interoperability. Further, the chassis 200 may be sufficiently compact that the multifunction appliance 100 may be unobtrusively installed into legacy mobile platforms or systems (e.g., bump-in-the-wire) or incorporated into state-of-the-art (SOTA) platforms. In either case, the multifunction appliance 100 may be easily upgraded to add new components or easily replaced by a succeeding version incorporating new cybersecurity tools as standards or requirements evolve.

In embodiments, the multifunctional cybersecurity appliance 100 may incorporate the following components. For example, the multifunctional cybersecurity appliance 100 may be implemented in a multi-slot hardened chassis 200, e.g., a three-slot 3 U VPX chassis. with the DMZ network 202, cryptographic modules 204, and next-generation firewall 206 (NGFW) each occupying a separate slot 200a within the chassis. In some embodiments, one or more of the modular components of the multifunctional cybersecurity appliance 100 (e.g., the DMZ network 202, cryptographic modules 204, and/or NGFW 206, as well as additional modular components as disclosed below) may share a slot 200a.

In embodiments, a demilitarized zone (DMZ) network 202 may serve as an outer perimeter or outer firewall for the multifunctional cybersecurity appliance 100. For example, the DMZ network 202 may implement one or more rulesets and/or policy sets to filter inbound data/communications traffic 208 into the internal processing environment 102. For example, the DMZ network 202 may inspect encrypted or unencrypted inbound packets according to rule sets/policy sets providing for acceptable formats, payloads, data ranges, IP addresses, network ports, integrity, and/or authenticity of the inbound packets. Further, if inbound packets comply with rulesets and/or policy sets implemented by the DMZ network 202, the inbound packets may be accepted and/or routed to a specific destination within the appliance 100 or within the internal processing environment 102 (e.g., unencrypted traffic may be forwarded directly to the NGFW 206, encrypted traffic to the cryptographic modules 204 for decryption). In some embodiments, inbound packets inspected by the DMZ network 202 may be allowed but flagged for downstream inspection or responsive action by the appliance 100 or the internal processing environment 102.

Similarly, the DMZ network 202 may further inspect outbound data traffic 210 passed by the NGFW 206. For example, the DMZ network 202 and NGFW 206 may implement distinct and different rulesets and/or policy sets. Accordingly, if outbound data traffic 210 (encrypted or unencrypted) inspected by the DMZ network 202 fails to comply with integrity checks or formatting rules implemented by the DMZ network, the outbound packet or packets may be dropped even if they have been passed by the NGFW 206.

In embodiments, the multifunctional cybersecurity appliance 100 may incorporate cryptographic modules 204 (e.g., NSA Type 1) configured for encryption of outbound communications and data traffic 210 and/or decryption of inbound communications and data traffic 208. For example, any inbound data/communications traffic 208 admitted by the DMZ network 202 may be decrypted and forwarded downstream for packet inspection (e.g., by the next-generation firewall 206 (NGFW)).

In embodiments, the multifunctional cybersecurity appliance 100 may incorporate a NGFW 206. For example, the next-generation firewall 206 may serve as a backup to, and implement a distinct set of rules and/or policies than, the DMZ network 202 with respect to inbound or outbound data and communications traffic 208, 210. With respect to inbound data/communications traffic 208, the DMZ network 202 may inspect and pass inbound packets according to its rules and/or policies, forwarding the accepted inbound packets to the cryptographic modules 204 for decryption. In embodiments, the NGFW 206 may inspect the decrypted packets, which may be rejected or dropped if the inbound packets include internal formatting, payload, integrity, validation or other inaccuracies and/or deficiencies that may not have been detectable by the DMZ network 202 when the inbound packets were encrypted.

In some embodiments, the multifunctional cybersecurity appliance 100 may incorporate security information and event management 212 (SIEM) modules. For example, the SIEM modules 212 may monitor event logs 214 generated by one or more components of the multifunctional cybersecurity appliance 100 (e.g., the DMZ network 202, cryptographic modules 204, and NGFW 206). Further, if one or more events logged by the various components of the multifunctional cybersecurity appliance 100, either alone or in combination, meet conditions indicative of a potential threat or exploit or suggest a potential threat or exploit (e.g., according to security policies enforced by the SIEM module 212), the SIEM module may generate an alert 216 (e.g., for other components of the multifunctional cybersecurity appliance (or elsewhere within the internal processing environment 102)).

In some embodiments, the SIEM module 212 may likewise monitor event logs 214 from other physical devices throughout the internal processing environment 102, e.g., locks 218 (e.g., door locks, window locks) or sensors 220 (e.g., cameras, motion detectors, proximity sensors). For example, event logs 214 generated by the locks 218 and/or sensors 220 may likewise contribute to alerts 216 generated by the SIEM module 212. Further, when the internal processing environment 102 is embodied in a vehicle or other mobile platform, the SIEM module 212 may similarly monitor event logs 214 from systems of devices and/or subsystems of the vehicle or mobile platform.

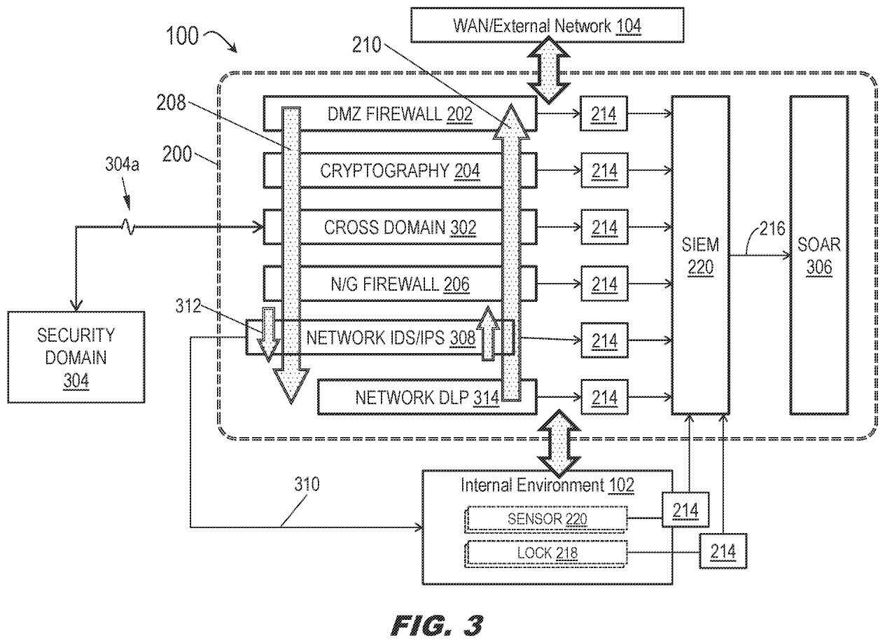

### FIG. 3—Additional Components

Referring now to FIG. 3, the multifunctional cybersecurity appliance 100 may be implemented with additional components as needed or desired. For example, the multifunctional cybersecurity appliance 100 may be implemented in a six-slot 6 U VPX chassis 200, where one or more of the additional components described below may be implemented in separate slots within the chassis, or may share a slot with the DMZ network 202, cryptographic module 204, or NGFW 206.

In embodiments, the multifunctional cybersecurity appliance 100 may incorporate cross-domain solutions 302 (CDS) for management of communications and data exchanges with other security domains, e.g., with a second security domain 304 (and/or across a security domain boundary 304a between the first and second domains) where the multifunction cybersecurity appliance and/or its embodying mobile platform (108, FIG. 1) is part of a first security domain, the first and second security domains operating according to different sets of security policies.

In embodiments, the SIEM module 212 may further incorporate security orchestration automation and response (SOAR) modules 306. For example, the SIEM module 212 may analyze event logs 214 and/or user logs to identify patterns, detect potential threats or exploits based on the identified patterns, and generate alerts 216 based on the detected threats or exploits. Further, the SOAR modules 306 may determine whether an event, threat, or exploit (e.g., or other deviation from expected activity identified by the SIEM module/s 212) triggering a SIEM alert 216 requires action, and implement specific countermeasures responsive to the alert.

In embodiments, the multifunctional cybersecurity appliance 100 may incorporate out-of-band network intrusion detection systems (IDS) and/or network intrusion prevention systems (IPS) 308. For example, network IDS/IPS 308 may share a slot with the NGFW 206, or may occupy a separate slot within the chassis 200. In embodiments, out-of-band network IDS may generate alerts 310, and/or network IPS may implement countermeasures responsive to these alerts, similarly to the SIEM and/or SOAR modules 212, 306, except that the network IDS/IPS systems may monitor the external network 104 and/or inbound and outbound data and communications traffic 208, 210 independently of the primary line of data traffic within the multifunctional cybersecurity appliance 100 (e.g., independently of the DMZ network 202, the NGFW 206, and/or other modular components as included; for example, the network IDS/IPS systems may inspect copies 312 of the inbound and outbound data traffic) to detect and/or counter potential anomalous behavior, exploits, or threats.

In embodiments, the multifunctional cybersecurity appliance 100 may incorporate network data loss prevention (DLP) modules 314. For example, network DLP modules 314 may similarly share a slot in the chassis 200 with the NGFW 206 and/or network IDS/IPS systems 308, or may occupy a dedicated slot. In embodiments, the network DLP modules 314 may filter inbound and outbound data traffic 208, 210 based on its associated security level or security classification, e.g., to prevent trends in data traversal that may be indicative of unusual behavior or attempted exfiltration of data. For example, if outbound data traffic 208 is in transit to a significantly less secure external network 104 (e.g., the security level or classification of the external network 104 sufficiently deviates from that of the outbound traffic, at or beyond a threshold level) the DLP modules 314 may reject or drop any packets associated with the outbound traffic. Similarly, if classified or high-security data streams are detected within a lower-security data stream in order to be transmitted from the internal processing environment 102 according to a laxer set of security rules or policies, the DLP modules 314 may likewise block or drop the associated data stream to prevent the exfiltration of classified data.

### CONCLUSION

It is to be understood that embodiments of the methods disclosed herein may include one or more of the steps described herein. Further, such steps may be carried out in any desired order and two or more of the steps may be carried out simultaneously with one another. Two or more of the steps disclosed herein may be combined in a single step, and in some embodiments, one or more of the steps may be carried out as two or more sub-steps. Further, other steps or sub-steps may be carried in addition to, or as substitutes to one or more of the steps disclosed herein.

Although inventive concepts have been described with reference to the embodiments illustrated in the attached drawing figures, equivalents may be employed and substitutions made herein without departing from the scope of the claims. Components illustrated and described herein are merely examples of a system/device and components that may be used to implement embodiments of the inventive concepts and may be replaced with other devices and components without departing from the scope of the claims. Furthermore, any dimensions, degrees, and/or numerical ranges provided herein are to be understood as non-limiting examples unless otherwise specified in the claims.

We claim:

1. A modular cybersecurity appliance attachable between an internal processing environment and at least one external network, the appliance comprising:
a demilitarized zone (DMZ) network configured for filtering of at least one of:
1) inbound data traffic associated with the internal processing environment,
or
2) encrypted outbound data traffic in transit to at least one external network,
based on a first set of one or more packet inspection rules;
at least one cryptographic module configured for:
encryption of the outbound data traffic;
and
decryption of the inbound data traffic;
at least one next generation firewall (NGFW) configured for filtering of at least one of:
1) decrypted inbound data traffic admitted by the DMZ network,
or
2) unencrypted outbound data traffic,
based on a second set of one or more packet inspection rules;
and
at least one security information and event management (SIEM) module configured for:
receiving an event log from at least one of the DMZ network, the cryptographic module, or the NGFW;
identifying at least one threat based on the at least one received event log;
and
generating at least one alert corresponding to the at least one identified threat.

2. The modular cybersecurity appliance of claim 1, wherein the at least one alert is a first alert, further comprising at least one out-of-band intrusion detection system (IDS) configured to:
1) monitor at least of the inbound data traffic and the outbound data traffic independently of the DMZ network and the NGFW;
2) identify at least one potential exploit based on the monitoring;
and
3) generate at least one second alert corresponding to the at least one identified potential exploit.

3. The modular cybersecurity appliance of claim 2, wherein the at least one alert is a first alert, further comprising:
at least one out-of-band intrusion prevention system (IPS) configured to execute at least one countermeasure in response to the at least one second alert.

4. The modular cybersecurity appliance of claim 1, further comprising:
at least one cross-domain solution (CDS) configured for transmission and reception of data between the internal processing environment and the at least one external network across a security domain boundary.

5. The modular cybersecurity appliance of claim 1, further comprising:
at least one network data loss prevention (DLP) module configured for filtering at least one of:
inbound data traffic admitted by the NGFW,
or
outbound data traffic received from the internal processing environment,
based on a security classification associated with the inbound data traffic or outbound data traffic.

6. The modular cybersecurity appliance of claim 5, wherein the security classification is a first security classification, and the at least one DLP module is configured for:
filtering at least one of the inbound data traffic or the outbound data traffic based on a deviation of the first security classification from a second security classification associated with the internal processing environment or the at least one external network.

7. The modular cybersecurity appliance of claim 1, wherein filtering the inbound data traffic includes at least one of:
accepting the inbound data traffic;
rejecting the inbound data traffic;
flagging the inbound data traffic;
or
routing the inbound data traffic to at least one destination within the internal processing environment.

8. The modular cybersecurity appliance of claim 1, wherein filtering the outbound data traffic includes at least one of:
accepting the outbound data traffic;
or
rejecting the outbound data traffic.

9. The modular cybersecurity appliance of claim 1, further comprising:
at least one security orchestration automation and response (SOAR) module communicatively coupled to the at least one SIEM module, the at least one SOAR module configured for executing at least one countermeasure responsive to the at least one alert.

10. The modular cybersecurity appliance of claim 1, wherein:
the at least one SIEM module is configured for receiving an event log from at least one of a physical device or a system of one or more devices associated with the internal processing environment.

11. The modular cybersecurity appliance of claim 10, wherein:
the internal processing environment is associated with a mobile platform;
and
the at least one of a physical device or a system includes at least one sensor associated with the mobile platform.

12. The modular cybersecurity appliance of claim 10, wherein:
the internal processing environment is associated with a mobile platform having at least one of a door or a window;
and
the at least one physical device or a system includes at least one lock configured to secure the door or the window.

13. The modular cybersecurity appliance of claim 1, wherein:
the internal processing environment is associated with a mobile platform;
and
the at least one physical device or a system includes at least one subsystem of the mobile platform.

14. The modular cybersecurity appliance of claim 1, comprising:
one or more physical interfaces configured for connecting the appliance to at least one of the internal processing environment or the at least one external network, each physical interface compatible with one or more protocols selected from a group including:
an Ethernet network;
a fiber channel network;
or
a MIL-STD-1553 data bus.
